(19) United States
(12) Patent Application Publication
(10) Pub. No.: US 2005/0256359 A1
(43) Pub. Date: Nov. 17, 2005

(54) Process for the oxidative degradation of toxic organic compounds

(75) Inventor: Friedrich Bolsing, Lindhorst (DE)

Correspondence Address: NORRIS, MCLAUGHLIN & MARCUS, P.A., 875 THIRD AVE, 18TH FLOOR, NEW YORK, NY, 10022, US

(73) Assignee: DCR International Environmental Services, B.V., Amsterdam (NL)

(21) Appl. No.: 10/842,821

(22) Filed: May 11, 2004

(51) Int. Cl. A62D 3/00

(52) U.S. Cl. 588/320

(57) ABSTRACT

The present invention relates to a process for the oxidative degradation of toxic organic compounds. It comprises mechanical and chemical activation of solids containing toxic organic compounds and subjecting said activated solids to heat spontaneously generated in the presence of oxygen to oxidatively degrade said toxic organic compounds.

The present invention relates to a process for the oxidative degradation of liquid or solid toxic organic compounds as such or as constituents in liquids or solids characterized in that the toxic organic compounds or the liquids or solids, containing the toxic organic compounds, are transferred into a highly reactive finely dispersed, pulverulent preparation and that said finely dispersed pulverulent preparation containing the toxic organic compounds is, in the form of a coherent mass, subjected to heat spontaneously generated after self-ignition inside said coherent mass in the presence of an oxidizing reagent.

Liquid and solid toxic organic compounds in this context means any sort of organic waste material, production residues, by-products and the like and comprises almost all chemical families, for instance, aliphatic and aromatic hydrocarbons, halogenated organics such as PCBs and “dioxins”, nitro compounds, aromatic amines and the like. These compounds may be present as contaminants in waste oil, combustion residues, soil and the like.

The hazard potential of toxic compounds is related with their individual toxicity, quantity, concentration and bioavailability. Accordingly, in order to decrease or even to abolish the hazard potential the mentioned parameters must be decreased, mainly toxicity and quantity. Toxicity and quantity can be decreased only in case of organic compounds.

The toxicity of organic compounds is related to special structural characteristics. For instance, PCBs and “dioxins” are extremely toxic because of the presence of chlorine in the basic molecule. PCBs and “dioxins” can, therefore, be detoxified by a complete removal of the attached chlorine, e.g. by replacing with hydrogen. This reductive dehalogenation of PCBs results in the formation of biphenyl, an almost non-toxic aromatic hydrocarbon. The reductive dehalogenation of “dioxins”, however, yields dibenzodioxin and dibenzofuran respectively as heteroaromatics which still own some toxicity. Accordingly, toxic organic compounds like “dioxins” can only be completely detoxified through dehalogenation and degradation of the whole molecules.

The quantity of toxic organic compounds can be decreased and even abolished through incineration. Incineration, however, is not always a detoxification process: “dioxins”, to keep the example, are very resistant to incineration and are even formed during incineration, in particular in waste incinerators.

A lot of methods have been proposed to detoxify toxic organic compounds by applying basic organic reactions: nucleophilic substitution, reduction and oxidation; most of said methods refer to the detoxification of PCBs and “dioxins” as contaminants in waste oil, combustion residues and soil.

Well known methods based on nucleophilic substitution, so-called NaPEG and KPEG methods, comprise the use of sodium or potassium polyether alkoxides prepared by reacting metallic sodium or potassium with the corresponding polyether alcohols, e.g. according U.S. Pat. Nos. 4,337,368 and 4,602,994, to name just two.

U.S. Pat. No. 5,108,647 provides a method for the dehalogenation of halogenated hydrocarbons in the presence of a nucleophilic reaction partner, comprising dispersing the halogenated hydrocarbon by chemical reaction (DCR) and dehalogenating said halogenated hydrocarbons at a temperature in the range of ambient temperature to approximately 510° C. in a closed system. Since the aromatic hydrocarbon skeleton is not affected, the reaction products, e.g. dibenzodioxin and dibenzofuran from “dioxins”, must either be immobilized or incinerated in a second step.

There are also a large number of prior art documents which describe processes for the reductive dehalogenation of halogenated hydrocarbons. According to EP 0 225 849 halogenated aliphatic or aromatic compounds are dehalogenated with sodium in an inert solvent in the presence of a proton donor at temperatures between 100 and 150° C. According to WO 95/18652 organohalides in liquids are reductively dehalogenated by grinding with an alkali metal in a ball mill in the presence of a hydrogen source. WO 94/14503 describes a process for the treatment of toxic materials, for example, inorganic compounds, halogenated organic compounds such as polychlorinated biphenyls (PCBs), dioxin and dichlorodiphenyl trichloroethane (DDT) and chemical weapons such as sarin and mustard. The process is based on the discovery that mechanical activation can induce chemical reactions which break down the molecular structure of toxic materials and form products which are simple, non-toxic compounds. The process involves subjecting a mixture of a toxic material and a suitable reagent to mechanical activation to produce a non-toxic end product. Mechanical activation is typically performed inside a mechanical mill, for example, a ball mill, e.g. a tower mill. Ball milling of various toxic materials with appropriate reagents was found to result in virtual total destruction of the toxic starting material.

According to U.S. Pat. No. 6,694,044 halogenated hydrocarbons are completely reductively dehalogenated, for instance, by ball milling with reducing metals in the presence of a hydrogen source and an amine at temperatures between room temperature and 400° C. According to U.S. Pat. No. 6,576,122 a complete reductive dehalogenation of halogenated hydrocarbons is achieved through transforming the halogenated hydrocarbons into a finely dispersed solid preparation and heating said preparation for a short time with finely dispersed reducing metals in the presence of a hydrogen source to a temperature between 80 to 400° C. in an oxygen-free atmosphere. In both processes halogen is replaced with hydrogen yielding, at least, significantly less toxic products; the basic hydrocarbon structure, however, is not affected, and, for instance, “dioxins” are converted into polycyclic aromatic hydrocarbons. It might therefore be necessary to incinerate or immobilize the dehalogenated compounds in a second step.

The drawbacks of methods comprising nucleophilic or reductive dehalogenation are obvious: all methods end up with the formation of less toxic but still problematic reaction products which make additional disposal steps necessary.

As a consequence, methods have been suggested to oxidatively degrade the whole toxic structure of toxic organic compounds.

According to U.S. Pat. No. 4,937,065 halogenated hydrocarbons are reacted in a reactor at temperatures up to 1000° C. with greater than stoichiometric amounts of calcium and/or magnesium silicates as oxygen source. In U.S. Pat. No. 4,582,613 copper(II)oxide is used as an oxygen source in a wet oxidation process. According to CA 2,096,891 waste water is treated in a catalytic wet air oxidation process in the presence of hydrogen peroxide. KR 2003,018,810 provides a degradation and dehalogenation method for “dioxins” comprising oxidation by Fenton's reagent (hydrogen peroxide plus iron(II) salts) and subsequent reaction with KOH and NaOH in the presence of polyethylene glycol. According to U.S. Pat. No. 6,632,973 “dioxins” and PCBs in liquid can be converted into harmless substances by oxygen containing gas and catalysts by a wet-oxidation reaction. EP 1,074,611 and EP 0,391,151 refer to microbiological degradation of “dioxins” and other multiple halogenated aromatic compounds using mold as degrading surrounding or specified bacteria. US 2003,024,879 describes an electrochemical oxidation of biological waste material in an aqueous medium.

The proposed methods do have some deficiencies. The high temperature methods are very costly: special control devices are necessary to achieve environmentally acceptable results; the other oxidative reactions are strongly bounded by their applicability to wet substrates only.

Therefore, it would be highly desirable to provide a process efficient to successfully detoxify toxic organic compounds using inexpensive reagents while producing environmentally safe degradation products.

In accordance with the present invention there is provided a process for the oxidative degradation of liquid or solid toxic organic compounds as such or as constituents in liquids or solids characterized in that the toxic organic compounds or the liquids or solids, containing the toxic organic compounds, are transferred into a highly reactive finely dispersed, pulverulent preparation and that said finely dispersed pulverulent preparation containing the toxic organic compounds is, in the form of a coherent mass, subjected to heat spontaneously generated after self-ignition inside said coherent mass in the presence of an oxidizing reagent

Liquid or solid toxic organic compounds as such or as constituents in liquids or solids are, in the sense of the present invention, aromatic nitro compounds, aromatic amines, halogenated organics, in particular chlorinated aromatics such as PCBs, “dioxins” (PCDDs/PCDFs), chlorinated phenols. Said toxic organic compounds may be present as such, i.e. as neat compounds, for instance neat solid DDT, or neat mixtures of compounds, for instance liquid PCBs, or as constituents of liquids, for instance PCBs dissolved in trichlorobenzene, or as contaminants in solids, for instance “dioxins” in combustion residues or PCBs in soil.

In accordance with the present invention said toxic organic compounds are transferred into a highly reactive finely dispersed, pulverulent preparation which is, in the form of a coherent mass, subjected to heat spontaneously generated after self-ignition inside said coherent mass in the presence of an oxidizing reagent.

In order to transfer a solid toxic organic compound or contaminated solids into said highly reactive finely dispersed, pulverulent preparation said solids are intensively milled in a grinding device. Any of the commercially available grinding devices may be suitable, for example tower mills, planetary mills, vibratory mills, attritor mills and gravity-dependent-type ball mills. In case the solid contains water to an extent that it cannot easily be ground, it must be chemically and/or physically dried beforehand. Chemical drying may be carried out through homogenizing the wet solid with a water consuming reagent, e.g. quicklime.

Liquids and contaminated liquids as well as wet contaminated solids may be transferred into said highly reactive finely dispersed, pulverulent preparation in the course of a dispersing chemical reaction (DCR), a process which has repeatedly been described, for instance in Donald L. Wise et al., Remediation Engineering of Contaminated Soils, Chapter 38, “Dispersing by Chemical Reactions Remediation Technology”, Marcel Dekker, Inc. (2000). In case the wet solid, e.g. a wet contaminated soil, is interspersed with coarse impurities the DCR reacted mass may be separated from said impurities by screen classification beforehand. This procedure is one of the most important embodiments of the present invention in view of practical applicability to soil remediation.

Finally, the highly reactive finely dispersed pulverulent preparation, prepared in either way, is, in the form of a coherent mass, subjected to heat spontaneously generated after selfignition inside said coherent mass in the presence of an oxidizing reagent. The oxidizing reagent may be aerial oxygen or oxygen.

In most cases intensive grinding or chemical dispersing yields a pyrophoric or almost pyrophoric powder of slightly increased temperature due to the grinding heat or to the exothermic dispersing chemical reaction. Temperatures may be in the range of 100° C. to 200° C. When exposing a preheated coherent mass to aerial oxygen, e.g. in an insulated reaction vessel, a spontaneous heat generation will commence after a while. It can be observed that heat is build up at some spots inside the coherent mass due to local initial oxidation process. From these points the heat spreads gradually through the whole mass accompanied by a significant change of color from dark to light. This spontaneous process would immediately be stopped when the local heat centers are distributed, e.g. by stirring. Therefore, it is essential to heat the highly reactive preparation in the form of an initially not disturbed coherent mass.

However, as soon as the heated zones have seized the whole mass it may be of advantage to smoothly move the mass in order to secure a complete oxidation by exposing to additional aerial oxygen. In accordance with these observations the oxidation process will totally be inhibited when the preheated mass is chilled immediately after having been taken from the mill.

In order to generate heat in an exothermic oxidation process oxidizable organic matter must be present in a sufficient concentration. Said oxidizable organic matter may be the toxic organic compounds provided their concentration is high enough or any other sort of easily oxidizable organic matter. This may be organic grinding aids, e.g. fatty acids and their salts, long-chain amines and alcohols, finely dispersed plastics such as polyethylene powder and the like; or reaction promoters, e.g. poly(ethylenglycol) as well as their mono- and dialkylethers, amines; or simply any other inert easily oxidizable non-toxic organic matter such as saw dust, charcoal and paraffins. The quantities necessary to generate the degradation temperatures can approximately be calculated from combustion enthalpy tables.

It could be shown that the aforementioned local heat centers are formed more easily in the presence of non-toxic organic matter containing a larger percentage of oxygen in the molecule.

Oxidative degradation of complex molecules, in particular of aromatic ring systems, proceeds more easily when at least partially reduced or when substituted with HO-groups. According to a preferred embodiment of the present invention the highly reactive finely dispersed, pulverulent preparation is milled in the presence of sodium as a reducing reagent and/or a nucleophilic reagent such as HO-ions from alkali- and/or earth alkali hydroxides. Aliphatic amines, ethers and alcohols may also be used as nucleophilic reagents.

The application of sodium in this context has some important benefits: sodium not only works as a reductant conditioning the toxic organic compounds for an easier oxidation but also as a source for one of the strongest oxidizing reagents. Grinding sodium together with a dry solid under an inert gas yields strongly pyrophoric sodium. On exposure to air the sodium immediately burns yielding sodium peroxide which easily oxidizes any sort of organic compounds. This process is utilized in another of the preferred embodiments of the present invention in that the toxic organic compounds are ground in the presence of not more than 5%, preferably between 0.1 and 1% of sodium thus ensuring that the peroxide formation takes place smoothly and is not accompanied by naked flames. Furthermore, in the presence of residual moisture in the highly reactive finely dispersed, pulverulent preparation containing the toxic organic compounds milling with sodium yields sodium hydroxide the HO-ions of which react as a nucleophile. This side reaction has the same benefit as the above described reductive conditioning. In both cases milling may be carried out in the presence of an inert gas.

The oxidative degradation of toxic organic compounds proceeds surprisingly easily in the presence of organic compounds with a polyether structure. It is assumed that this might be due to the formation of ether peroxides from mechanically or chemically activated polyethers on exposure to aerial oxygen.

As has been pointed out above the spontaneous post-treatment heat generation inside the mechanically or chemically activated solid preparation can be suppressed by immediate chilling said preparation when leaving the grinding device. This can be achieved through spreading said preparation in a thin layer on a cool surface, e.g. on a metallic plate. On the other hand, in case that the starting temperature of the ground or chemically dispersed mass is not high enough to cause a spontaneous heat generation said mass may be heated externally in a heatable reaction vessel until the spontaneous heat generation will commence. In order to support local self-ignition processes oxygen in a higher concentration than in air may be applied. In order to increase the heat transfer inside the solid matrix a finely dispersed metal, preferably iron or aluminum may be added, e.g. to an extent of 0.5 to 5%, immediately after the ground mix has left the grinding device. In order to ensure a complete oxidative degradation the heating step may be carried out in a heatable reaction vessel, reactor tube, intensive mixer, solid bed reactor or solid flow reactor in which the heated coherent mass and the oxygen or aerial oxygen are in a countercurrent contact.

The oxidative degradation processes according to the present invention may be applied to degrade and detoxify toxic organic compounds as such or as contaminants in waste oil, hydraulic oil, transformer oil, condenser oil, filter dust, ashes, soils, industrial byproducts and industrial waste.

### EXAMPLE 1

16 g of water are added to a mixture of 20 g of waste oil containing polycyclic aromatics and 56 g of calcium oxide. A dispersing chemical reaction takes place (DCR). The resulting hot brown powder is stored in an insulating block of polystyrene. After about 20 min a subsequent exothermic reaction commences spontaneously and the organic matter is oxidized quantitatively whereby the color changes to light-grey.

### EXAMPLE 2

100 g dry fly ash homogeneously spiked with 2 mmol (=324 mg) 1-chloronaphthalene and 2 mmol (=474 mg) bis(p-chlorophenyl)methane was ground under nitrogen together with 0.5 g stearic acid, 500 mg sodium and 1 g tetraglyme for 60 minutes in a centrifugal ball mill (500 ml stainless steel grinding jar, 4 hardened steel balls Ø 40 mm). The balls were removed by sieving at the open air and the resulting brownish powder was stored in a beaker wrapped with a heating tape at about 150° C. After a hold-up time of 120 min the rate of dehalogenation was 79%. When the ground powder was not stored at 150° C. but immediately spread on an iron plate after the rate of dehalogenation was 81%. However, when 8 g of paraffin oil were added to the sample before grinding the temperature of the heated sample spontaneously rose up to 410° C. and the dehalogenation rate was >99.8%; the corresponding rate of the not heated sample was 51.2% only.

### EXAMPLE 3

When 100 g dry fly ash homogeneously spiked with 2 mmol (=324 mg) 1-chloro-naphthalene and 2 mmol (=474 mg) bis(p-chlorophenyl)methane were ground under nitrogen together with 1 g stearic acid and 1.5 g tetraglyme and treated as described in Example 2 the rate of dehalogenation in the not heated sample was about 5.5% and in the heated sample 99.1%. When 10 g saw dust were added additionally before grinding the dehalogenation rate was 99.9%. The maximum temperatures were 410° C. and 455° C. respectively.

### EXAMPLE 4

The fly ash of Example 2 was replaced with a natural clayey soil dried for 24 h at 120° C. beforehand. The rate of dehalogenation in the presence of paraffin oil in the not heated sample was 53.4% and in the heated sample 99.9%. The former low degradation rate is apparently due to the fact that residual moisture in the clayey soil reacts with the sodium to form sodium hydroxide and it is only the subsequent oxidative step which yields a complete degradation. Accordingly, in this example the sodium may be replaced just as well with sodium hydroxide to give the same result.

### EXAMPLE 5

To 100 g natural wet clayey soil 20 g of waste oil were added spiked with 2 mmol (=324 mg) 1-chloronaphthalene and 2 mmol (=474 mg) bis(p-chlorophenyl)methane. This pasty mixture was reacted with 56 g of calcium oxide hydrophobized with 1% stearyl-amine to give a brown dry powder, which was stored at 150° C. until a subsequent exothermic reaction commenced spontaneously showing a temperature increase up to 455° C. The dehalogenation rate was 99.9%.

1. A process for the oxidative degradation of liquid or solid toxic organic compounds as such or as constituents in liquids or solids, comprising the steps, transferring the toxic organic compounds or the liquids or solids containing the toxic organic compounds into a highly reactive finely dispersed, pulverulent preparation, wherein said finely dispersed pulverulent preparation containing the toxic organic compounds is in the form of a coherent mass, and subjecting said coherent mass to spontaneously generated heat, wherein said heat is generated by self-ignition inside said coherent mass in the presence of an oxidizing reagent.

2. The process according to claim 1, wherein the highly reactive finely dispersed, pulverulent preparation containing the toxic organic compounds is prepared from said liquid or solid toxic organic compounds as such or as constituents in liquids or solids, through drying and subsequent mechanical disintegration, or by means of a dispersing chemical reaction (DCR).

3. The process according to claim 2, wherein the mechanical disintegration is achieved by milling in a ball mill.

4. The process according to claim 1, characterized in that the highly reactive finely dispersed, pulverulent preparation containing the toxic organic compounds is prepared in the presence of additional non-toxic organic compounds such as grinding aids, reaction promoters and easily oxidizable organic matter as a source of energy for said spontaneous heat generation.

5. The process according to claim 4, characterized in that the grinding aids, reaction promoters and easily oxidizable organic matter are selected from the group consisting of paraffins, harmless aromatics, alcohols. in particular poly(ethylene glycols), ether, in particular mono- and di-ethers of said poly(ethylene glycols), amines, long-chain organic acids or mixtures thereof.

6. The process according to claim 1, wherein the highly reactive finely dispersed, pulverulent preparation containing the toxic organic compounds is prepared in the presence of a nucleophilic reagent.

7. The process according to claim 6, characterized in that the nucleophilic reagent is selected from the group consisting of HO-ions from an alkali or earth alkali hydroxide; amines, ethers, and alcohols.

8. The process according to claim 1, wherein the milling step is carried out in the presence of an inert gas.

9. The process according to claim 1, wherein the oxidizing reagent is oxygen or aerial oxygen.

10. The process according claim 1, wherein the oxidizing reagent is a peroxide.

11. The process according to claim 10, wherein the oxidizing reagent is a polyether peroxide or sodium peroxide.

12. The process according to claim 10, wherein the polyether peroxide or sodium peroxide formed in situ through a) chemically dispersing or milling the corresponding polyether or metallic sodium together with the toxic organic compounds as such or as constituents in liquids or solids and b) exposing the pulverulent mixture containing the finely dispersed ether or metallic sodium to oxygen or aerial oxygen in the course of the subsequent heating step.

13. The process according to claim 12, wherein the heating step comprises heating through spontaneous heat generation resulting from internal oxidation processes of the additionally added non-toxic organic compounds in the pulverulent reaction mixtures and, and optionally, external heating by means of a heating device.

14. The process according to claim 1 comprising
a) grinding a solid containing the toxic organic compounds with sodium under inert gas in the presence of a grinding aid and, optionally, a reaction promoter and, optionally, an easily oxidizable non-toxic organic compound and
b) transferring said ground mixture in the presence of aerial oxygen into an insulated heatable reaction vessel and
c) subjecting said ground mixture to heat spontaneously generated in the presence of oxygen or aerial oxygen until the oxidizing reaction has ceased.

15. The process according to claim 1, comprising
a) drying a solid containing the toxic organic compounds
b) grinding said solid under inert gas in the presence of a grinding aid and, optionally, a reaction promoter and, optionally, an easily oxidizable non-toxic organic compound and, optionally, a nucleophile under nitrogen,
c) transferring said ground mixture in the presence of aerial oxygen into a reaction vessel and, and
d) subjecting said ground mixture to heat spontaneously generated in the presence of oxygen or aerial oxygen until the oxidizing reaction has ceased.

16. The process according to claim 1, comprising
a) reacting solids or liquids containing the toxic organic compounds in a DCR reaction in the presence of a grinding aid and, optionally, a reaction promoter and, optionally, an easily oxidizable non-toxic organic compound and, optionally, a nucleophile
b) grinding said mixture with sodium under inert gas
c) transferring said ground mixture in the presence of aerial oxygen into a reaction vessel and
d) subjecting said ground mixture to heat spontaneously generated in the presence of oxygen or aerial oxygen until the oxidizing reaction has ceased.

17. The process according to claim 1 comprising
a) reacting solids or liquids containing the toxic organic compounds in a DCR reaction in the presence of a reaction promoter and, optionally, an easily oxidizable non-toxic organic compound and, optionally, a nucleophile
b) transferring said ground mixture in the presence of aerial oxygen into a reaction vessel and
c) subjecting said ground mixture to heat spontaneously generated in the presence of oxygen or aerial oxygen until the oxidizing reaction has ceased.

18. The process according to claim 1, wherein the oxidizing reaction is carried out in a heatable reaction vessel that permits the heated coherent mass and the oxygen or aerial oxygen to be in a countercurrent contact.

19. The process of claim 1, wherein the toxic organic compounds comprise contaminants in one or more materials selected from the group consisting of waste oil, hydraulic oil, transformer oil, condenser oil, filter dust, ashes, soils, industrial byproducts and industrial waste.

20. The process of claim 5, wherein the grinding aids, reaction promoters and easily oxidizable organic matter are selected from the group consisting of poly(ethylene glycols), ether, mono-ethers of poly(ethylene glycols), di-ethers of poly(ethylene glycols), amines, and long-chain organic acids, or mixtures thereof.

21. The process of claim 18, wherein the heatable reaction vessel is selected from the group consisting of reactor tube, intensive mixture, solid bed reactor or solid flow reactor.
